(19) United States
(12) Patent Application Publication
(10) Pub. No.: US 2007/0251396 A1
(43) Pub. Date: Nov. 1, 2007

(54) Device for serving hot consumption liquids

(76) Inventors: Ferdinand Pierre Hubertus Stoter, Eindhoven (NL); Antonius Wilehelmus Bernardus Boogers, Helmond (NL)

Correspondence Address: LAW OFFICES OF ERIC KARICH, 2807 ST. MARK DR., MANSFIELD, TX, 76063, US

(21) Appl. No.: 11/716,191

(22) Filed: Mar. 9, 2007

(30) Foreign Application Priority Data
Sep. 10, 2004 (NL) NL 1027022
Sep. 12, 2005 (NL) PCT/NL05/00663

(51) Int. Cl. A47J 31/02

(52) U.S. Cl. 99/287

(57) ABSTRACT

A device for serving hot consumption liquids has a storage kettle with a spout in the middle of the bottom. The device preferably includes a covering device, which covers the consumption liquid in the storage kettle during operation, and ensures that the consumption liquid is not exposed to the air present in the storage kettle above the consumption liquid. To keep the soup homogeneous, the device has stirrers, which comprise a stirring element that is connected to an electrical motor. A double-bladed propeller forms the stirring element, the blades of which are twisted 45 degrees. The blades protrude essentially parallel to the bottom of the storage kettle.

### BACKGROUND OF THE INVENTION

1. Field of the Invention

The invention relates to a device for serving hot consumption liquids, especially soup, comprising: a storage kettle provided with a bottom and a spout, heating devices to heat the contents of the storage kettle, dispensing devices, which are connected to the spout for the measured issue of the consumption liquid, and stirrers present in the storage kettle to stir the contents of the storage kettle.

2. Prior art

Such a device is known from the international patent application with publication number WO-A-03/070073. Air is blown into the storage kettle near the bottom by means of a compressor to ensure that the consumption liquid is of constant quality. The rising air bubbles ensure that the consumption liquid remains of homogeneous composition.

### SUMMARY OF THE INVENTION

An objective of the invention is to provide a device of the type described in the preamble in which the quality of the consumption liquid remains better than in the known device. To this end, the device according to the invention is characterized in that the device also comprises a covering device that is present on the liquid in the storage kettle during operation. This ensures that the consumption liquid is not exposed to the air in the storage kettle above the consumption liquid. It has appeared that condensation causes the quality of the consumption liquid to deteriorate. If the consumption liquid is soup, condensation causes it to thicken and become. saltier as water evaporates from the soup.

The covering device could be a plate, which is fastened to the lid of the storage kettle by a compression spring. An embodiment of the device according to the invention is characterized in that the covering device is made so that it floats on the consumption liquid present in the storage kettle during operation.

The covering device can for example be a hollow disc. Preferably, however, the covering device is a disc with a specific gravity less than that of the consumption liquid for which the device is used, for example less than that of water or less than that of soup.

A further embodiment of the device according to the invention is characterized in that the bottom of the storage kettle is funnel-shaped and the stirrers contain a stirring element that is formed by a propeller with twisted blades, which are essentially parallel to the bottom of the storage kettle. This means that the contents of the storage kettle are kept homogeneous better than in the known device. The blades of the stirring element are preferably twisted approximately 45 degrees.

Note that this embodiment of the stirrers can also be used independently of the application of the above covering devices.

Moreover, the device preferably comprises a control unit, which alternately turns the stirring element right and left. This stirs the consumption liquid and does not cause turbulence so that the different constituents of the consumption liquid are blended equally in the consumption liquid.

Still a further embodiment of the device according to the invention is characterized in that the heating devices comprise a water circuit, a pump for pumping water around the water circuit, and a heating element to heat the water in the water circuit, and that the storage kettle is at least double-walled, in which the space between the walls is part of the water circuit. This efficiently keeps the consumption liquid at the correct temperature.

There are preferably one or more transverse walls between the walls of the storage kettle, which are optionally provided with flow-through openings to move the water through the wall better. One helical transverse wall without openings can also be used instead of separate transverse walls with flow-through openings. In this case there is a helical duct in the wall so that the water can flow along the whole wall better.

An embodiment of the device is characterized in that the dispensing devices comprise a vane pump, which pumps consumption liquid out of the storage kettle via the spout and also admits air via the spout at the bottom of the storage kettle in order to homogenize the composition of the consumption liquid even better. As the air is admitted via the spout, the rising air bubbles ensure that heavy constituents in the consumption liquid, which precipitate towards the spout, are pushed away and therefore the composition is kept better homogeneous.

Preferably the vane pump comprises a rotor with a shaft provided with radially protruding blades, which rotor is present in a rotor housing of the vane pump, and which rotor housing is cylindrical, in which the cylinder jacket is provided with an inlet opening and an outlet opening and is at least partly double-walled, in which the space between the walls is also part of the water circuit of the heating devices. This keeps the consumption liquid in the pump at the correct temperature.

### BRIEF DESCRIPTION OF THE DRAWINGS

The invention will be elucidated more fully below on the basis of drawings in which an embodiment of the device according to the invention is shown. In these drawings:

FIG. 1 shows an embodiment of the device according to the invention in perspective; and

FIG. 2 shows a cut-away storage kettle with pump and stirrers in perspective.

### DETAILED DESCRIPTION OF THE DRAWINGS

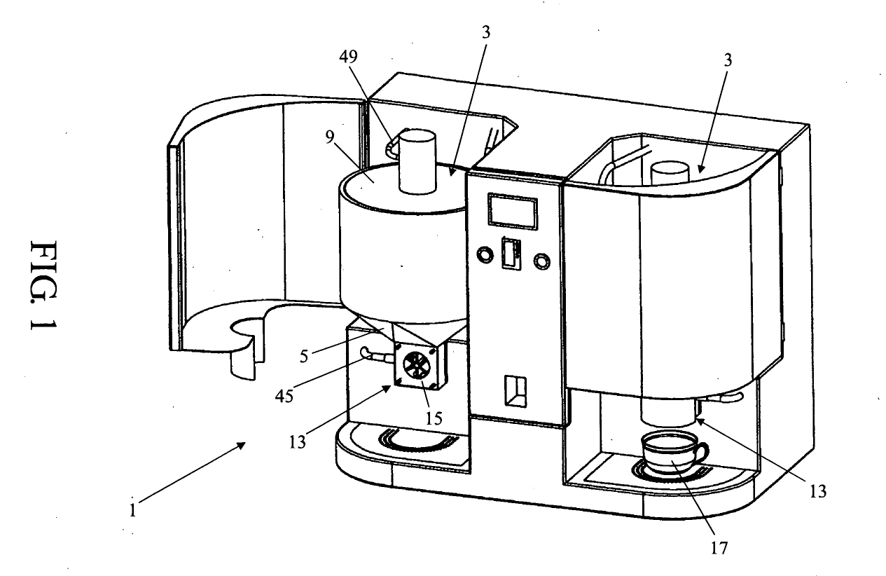

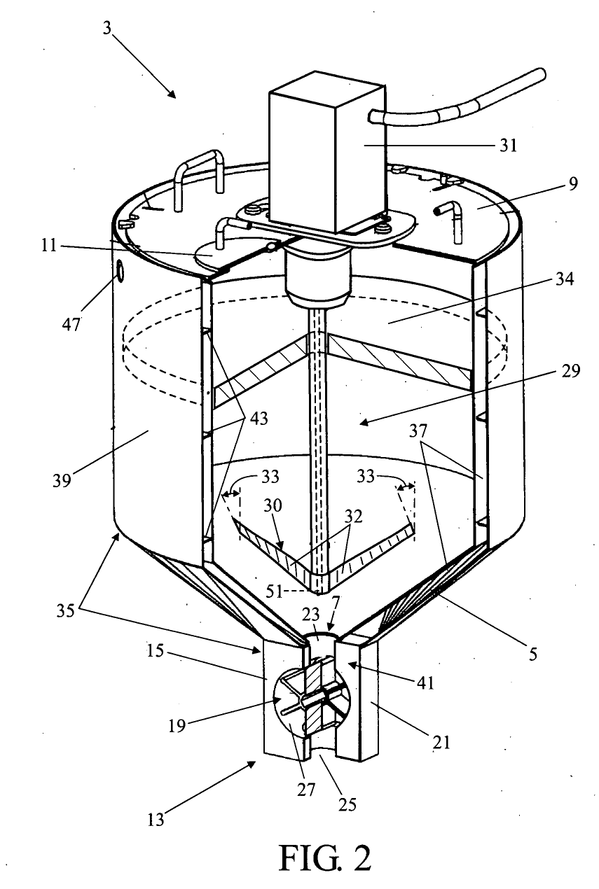

FIG. 1 shows an embodiment of the device according to the invention in perspective. The device 1 has two storage kettles 3 for two different soups. The storage kettles have a funnel-shaped bottom 5 with a spout 7 in the middle, see FIG. 2, in which the storage kettle 3 is shown partly cut away in perspective. There is a filling opening closed by a cap 11 in the removable lid 9 of the storage kettle. Dispensing devices 13 are fastened on the bottom of the funnel-shaped bottom 5, which are connected to the spout 7.

The dispensing devices 13 are formed by a vane pump 15, which pumps the soup out of the storage kettle into a soup cup 17 and also admits air via the spout 7 at the bottom of the funnel-shaped bottom 5 of the storage kettle 3, so that heavier constituents in the soup are blown away from the spout. This keeps the composition of the soup more homogeneous. The vane pump 15 has a rotor 19, which is formed by a shaft provided with flexible, radially protruding blades, a so-called impeller pump. The rotor is housed in a slightly elliptical rotor housing 21 (for the build up of pressure in the chambers between the blades), which is provided with a radially directed inlet opening 23 and an outlet opening 25 in the cylinder wall 27 of the rotor housing.

The rotor 19 is connected to an impulse counter (not visible in the figures), which is connected to the control devices of the pump, in order to measure out the quantity of issued soup accurately.

The device 1 also has stirrers 29 to stir the contents of the storage kettle, see FIG. 2, to keep the soup even better homogenized. The stirrers have a stirring element 30 that is connected to an electrical motor 31. The stirring element 30 is formed by a doubled-bladed propeller, the blades 32 of which are twisted 45 degrees. An end of the blades 32 is here fastened to the drive shaft, in which the latitudinal direction of the blade protrudes vertically. The latitudinal direction of the other end of the blades 32 is at an angle 33 of 45 degrees to the vertical. The blades 32 also essentially protrude parallel to the bottom 5 of the storage kettle 3.

The electrical motor 31 is connected to an electronic control unit (not visible in the figures), which alternately turns the stirring element 30 right and left. This ensures that no disadvantageous eddies build up in the soup, which would cause the heavier constituents to precipitate.

There is a covering device 34 in the storage kettle to prevent evaporation of the soup and condensation. A disc, which can be pushed along the drive shaft of the stirring element, and which is made of a material with a specific gravity less than that of water so that it floats on the soup during operation, forms these covering device 34.

The device 1 also has heating devices 35 to heat the contents of the storage kettle. The heating devices have a heating element, for example a heating spiral (not visible in the figures), and a water circuit with an expansion vessel (also not visible). The water circuit is formed by a duct 37 in the wall 39 of the storage kettle and a space 41 in the wall of the rotor housing.

The wall 39 of the storage kettle is double, in which there are transverse walls 43 between the walls, which are provided with several flow-through openings (not visible in the figures). The rotor housing 21 is also double-walled, in which the space 41 between the walls of the rotor housing is connected to the duct 37 in the wall of the storage kettle. There is a water inlet opening in the rotor housing 21 to which a water supply pipe 45 of the heating devices is connected, see FIG. 1. There is a water outlet opening 47, see FIG. 2, at the top of the wall 39 of the storage kettle, to which a water drain pipe 49 is connected. The water pipes 45 and 49 are connected to a water pump (not visible in the figures) of the heating devices.

There is a temperature sensor 51 at the bottom of the drive shaft of the stirrers to keep the soup at the desired temperature. This temperature sensor 51 is connected to the heating devices.

Although in the above the invention is explained on the basis of the drawings, it should be noted that the invention is in no way limited to the embodiment shown in the drawings. The invention also extends to all embodiments deviating from the embodiment shown in the drawings within the context defined by the claims.

1. A device for serving hot consumption liquids, comprising:
a storage kettle provided with a bottom and a spout, the storage kettle being adapted to contain the hot consumption liquids;
a heating device to heat the hot consumption liquids;
a dispensing device connected to the spout for the measured issue of the hot consumption liquids; and
a stirrer present in the storage kettle to stir the hot consumption liquids in the storage kettle.

2. The device of claim 1, further comprising a covering device, which is present on top of the consumption liquid in the storage kettle during operation.

3. The device of claim 1, characterized in that the bottom of the storage kettle is funnel-shaped and the stirrer comprises a stirring element, which is formed by a propeller with twisted blades, which are essentially parallel to the bottom of the storage kettle.

4. The device of claim 3, characterized in that the blades of the stirring element are twisted approximately 45 degrees.

5. The device of claim 3, further comprising a control unit adapted to alternately turn the stirring element right and left.

6. The device of claim 1, wherein the heating device includes a water circuit, a pump to pump water around the water circuit, and a heating element to heat the water in the water circuit, and that the storage kettle is at least doubled-walled, in which the space between the walls is part of the water circuit.

7. The device of claim 1, characterized in that the dispensing device comprises a vane pump, which pumps consumption liquid out of the storage kettle via the spout and admits air via the spout at the bottom of the storage kettle.

8. The device of claim 7, wherein the vane pump comprises a rotor with a shaft provided with radially protruding blades, which rotor is housed in a rotor housing of the vane pump, and which rotor housing is cylindrical, in which the cylinder jacket is provided with an inlet opening and an outlet opening and is at least doubled-walled, in which the space between the walls is also part of the water circuit of the heating devices.

9. The device of claim 1, further comprising one or more transverse walls between walls of the storage kettle.

10. The device of claim 9, further comprising flow-through openings through the transverse walls.
